(19) United States
(12) Patent Application Publication
(10) Pub. No.: US 2004/0212883 A1
(43) Pub. Date: Oct. 28, 2004

(54) Planar polarization beam combiner/splitter

(75) Inventor: Bruce P. Jacobsen, Monrovia, CA (US)

Correspondence Address: HITT GAINES P.C., P.O. BOX 832570, RICHARDSON, TX, 75083, US

(73) Assignee: Agere Systems Inc., Allentown, PA (US)

(21) Appl. No.: 10/219,985

(22) Filed: Aug. 15, 2002

(51) Int. Cl. G02B 5/30; G02B 27/28; H04J 14/02

(52) U.S. Cl. 359/487

(57) ABSTRACT

The present invention provides a method of combining or splitting optical signals having differing polarities, as well as an optical device for performing the method and an optical communications system employing the optical device. The method includes directing first and second optical signals at a non-immersed, transflective surface of an optical component. The method further includes reflecting from the non-immersed, transflective surface the first optical signal, which has a first polarity, and transmitting through the non-immersed, transflective surface the second optical signal, which has a second polarity.

### TECHNICAL FIELD OF THE INVENTION

The present invention is directed, in general, to optical devices and methods and, more specifically, to a method and device for combining or splitting polarized optical signals.

### BACKGROUND OF THE INVENTION

It is often necessary to combine light from two linearly polarized sources into a single fiber. This is performed in order to obtain an increase in power over a single source, and also to ensure a proper distribution of polarization states in the output fiber. A typical application of such combination would be in combining the light from two linearly polarized lasers of the same wavelength into a single output fiber.

Previous attempts to perform such signal combination included the use of immersed, thin film coatings placed in the optical paths of the two polarized signals. An immersed coating is one that has a material having a high index of refraction on the outside of the coating, such as epoxy, as compared to a material having a low index of refraction, such as air. Turning briefly to FIG. 1, illustrated is one example of a prior art beam combiner 100. The beam combiner 100 of FIG. 1 includes a first prism 110 and a second prism 120 coupled to opposite ends of an epoxy body 130. Alternatively, the body 130 may comprise material being substantially optically transparent, wherein the body 130 is typically epoxied to the first and second prisms 120 and 130. In the illustrated embodiment, a vertically polarized signal 140 enters the combiner 100 and is reflected twice. The first reflection is off of a high reflective coating on a surface 150 of the first prism 110. The second reflection is off of a thin film, polarizing coating on a surface 160 of the second prism 120, wherein the coating is designed to reflect vertically polarized light and transmit horizontally polarized light. A horizontally polarized signal 170 is passed through the polarizing coating, thereby becoming combined with the vertically polarized signal 140 to form a combined signal 180.

A disadvantage of such a device is that it requires the use of epoxy in the path of the optical signals. There is a significant danger that, at high power levels, this epoxy may fail, thereby ruining the device. Therefore, such devices have an inherent power limit much lower than an epoxy-free device.

Other attempts to perform signal combining include the use of a walk-off prism, as shown in prior art FIG. 2. As illustrated, the prior art beam combiner 200 includes a conventional birefringent crystal 210 oriented in such a way that it has a different index of refraction for a horizontally polarized optical signal 220 as compared to a vertically polarized optical signal 230. A prism 240 is used to bring the vertically polarized optical signal 230 into close proximity of the horizontally polarized optical signal 220. The two slightly offset signals 220 and 230 each enter the birefringent crystal 210. The difference in polarization of the two signals 220 and 230 causes a different angle of refraction within the birefringent crystal 210. The two signals 220 and 230 progressively overlap as they traverse the birefringent crystal 210. The signals 220 and 230 exit the birefringent crystal 210 parallel to each other and overlapped in a single, combined signal 250.

There are also disadvantages to this design. For instance, the design requires the capability for growing, orienting, cutting and polishing birefringent material, which can be complex, expensive and labor-intensive. In addition, there is an inherent temperature dependence in the crystal that affects the overall efficiency of the combiner 200 over typical operating temperature ranges.

It is also often necessary to split an input light source into two, linear, orthogonally polarized outputs. Typically, the output polarization states need to be very pure, though that is not always the case. This function is necessary from time to time with various optical devices.

The issue of creating a polarizing splitter is often solved by using either of the two prior art devices disclosed above in reverse. However, problems inherent in the prior art devices when used as beam combiners are still inherent in the prior art devices when used in reverse as beam splitters. In addition, the prior art designs used in reverse often do not have the necessary purity of polarization needed for many applications.

Accordingly, what is needed in the art is a method and device for combining and/or splitting orthogonally polarized optical signals, wherein the method and device overcome the disadvantages of the prior art.

### SUMMARY OF THE INVENTION

To address the above-discussed deficiencies of the prior art, the present invention provides a method of combining or splitting optical signals having differing polarities, as well as a device for performing the method and an optical communications system employing the device or method. The method includes directing first and second optical signals at a non-immersed, transflective surface of an optical component. The method further includes reflecting from the non-immersed, transflective surface the first optical signal, which has a first polarity, and transmitting through the non-immersed, transflective surface the second optical signal, which has a second polarity.

The foregoing has outlined an embodiment of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

The invention is best understood from the following detailed description when read with the accompanying FIGUREs. It is emphasized that, in accordance with the standard practice in the industry, various features are not drawn to scale. In fact, the dimensions of the various features may be arbitrarily increased or reduced for clarity of discussion. Reference is now made to the following descriptions taken in conjunction with the accompanying drawings, in which:

FIG. 1 illustrates a diagram of a prior art optical beam combiner;

FIG. 2 illustrates a diagram of another prior art optical beam combiner;

FIG. 3 illustrates a flowchart depicting one embodiment of a method of combining optical signals having different polarities according to the principles of the present invention;

FIG. 4 illustrates a flowchart depicting one embodiment of a method of splitting an optical signal into optical signals having different polarities according to the principles of the present invention;

FIG. 5 illustrates a plan view of one embodiment of an optical device used to combine optical signals having different polarities, constructed according to the principles of the present invention;

FIG. 6 illustrates a plan view of one embodiment of an optical device used to split an optical signal into optical signals having different polarities, constructed according to the principles of the present invention; and

FIG. 7 illustrates a plan view of one embodiment of an optical communications system constructed according to the principles of the present invention.

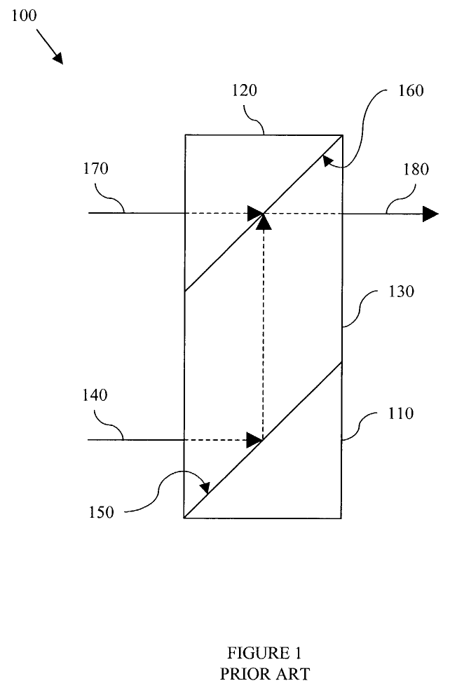

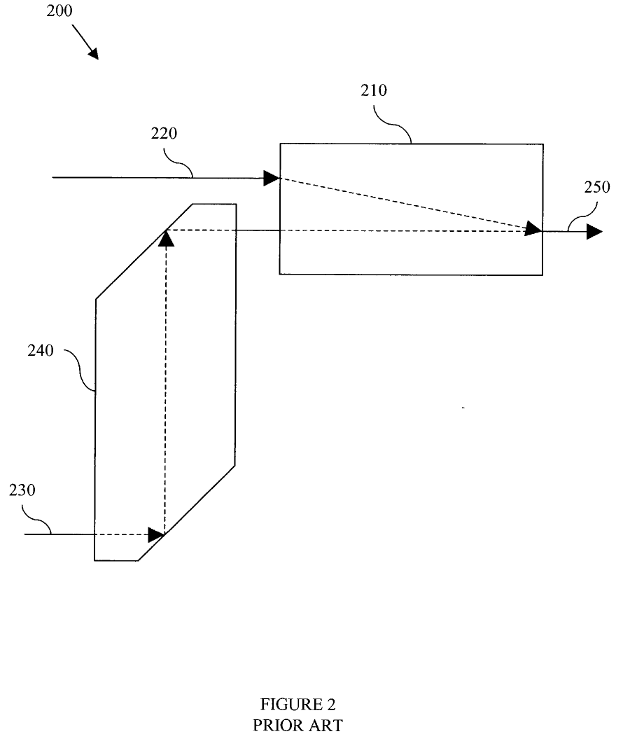

### DETAILED DESCRIPTION

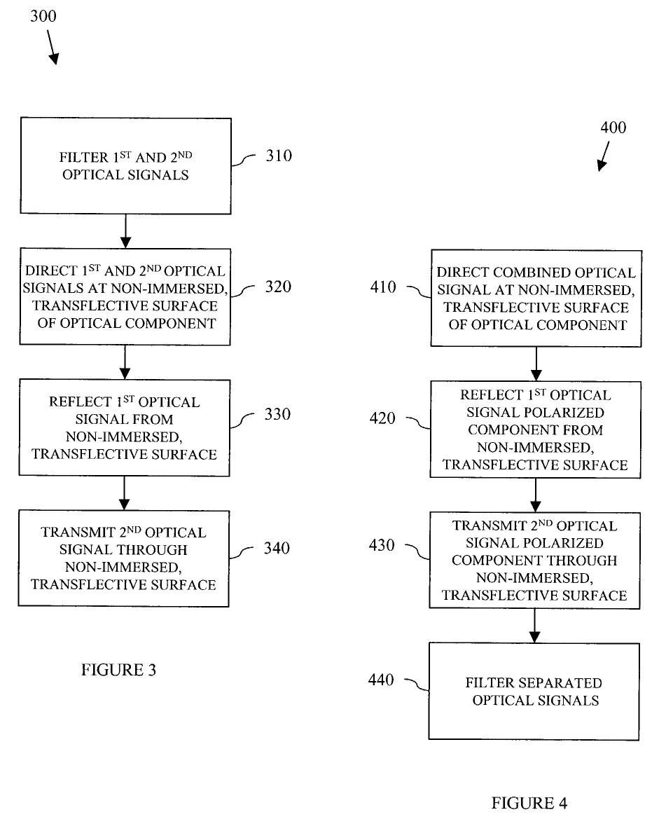

Referring initially to FIG. 3, illustrated is a flowchart depicting one embodiment of a method 300 of combining optical signals having different polarities. The method 300 may begin at a step 310, wherein first and second optical signals having different polarities may be individually or collectively filtered or collimated, such as to improve the purity of the polarization. The two optical signals may overlap one another, or, alternatively, may be discrete optical signals. It should be noted that the step 310 is an optional step, and is not required.

In a step 320, both of the optical signals are directed at a non-immersed, transflective surface of an optical component. By non-immersed, it is intended that the non-immersed, transflective surface has nothing other than a transflective coating located thereon. For instance, the non-immersed, transflective surface has no epoxy or other adhesives thereon. In another embodiment, the non-immersed surface may intend a surface surrounded only by air or another inert gas, but not having an adhesive bonded thereto. In one embodiment, the non-immersed surface may intend a surface having located thereon only materials having a low index of refraction. Such a low index of refraction may range from about 1.0000 to about 1.0050. By contrast, an immersed surface intends one that has a material having a high index of refraction, such as epoxy, on the outside of the surface.

In a step 330, the non-immersed, transflective surface reflects the first optical signal, which has a first polarity. In a step 340, the non-immersed, transflective surface transmits the second optical signal, which has a second polarity. The second polarity may be orthogonal to the first polarity. In an advantageous embodiment of the present invention, the step 340 may be performed simultaneously with the step 330. By directing the two optical signals at the non-immersed, transflective surface, the reflection of the first optical signal may overlap with the transmission of the second optical signal, the two signals thereby being combined into a single, complex signal having different polarities.

A similar method 400 may be used to split a complex optical signal having multiple polarization components. A flowchart depicting one embodiment of the method 400 is shown in FIG. 4. The method 400 may begin at a step 410, wherein the complex optical signal having multiple polarization components is directed at a non-immersed, transflective surface of an optical component.

In a step 420, a first polarized component of the complex optical signal may be reflected by the non-immersed, transflective surface. In a step 430, a second polarized component may be transmitted through the non-immersed, transflective surface. The first and second polarized components may have orthogonal polarities. In an advantageous embodiment of the present invention, the step 430 may be performed simultaneously with the step 420. By directing the complex optical signal having multiple polarized components at the non-immersed, transflective surface, a first optical signal having a first polarity may be split or separated from a second optical signal having a second polarity, thereby providing two distinct optical signals of different polarization. The separated optical signals may have a polarization purity ratio of up to 99.9%. In an advantageous embodiment, the separated optical signals may have a polarization purity ratio ranging between about 99.0% and about 99.9%.

In a step 440, the separated optical signals having different polarizations may be individually or collectively filtered or collimated to improve the purity of the polarizations and/or adjust the extinction ratio thereof.

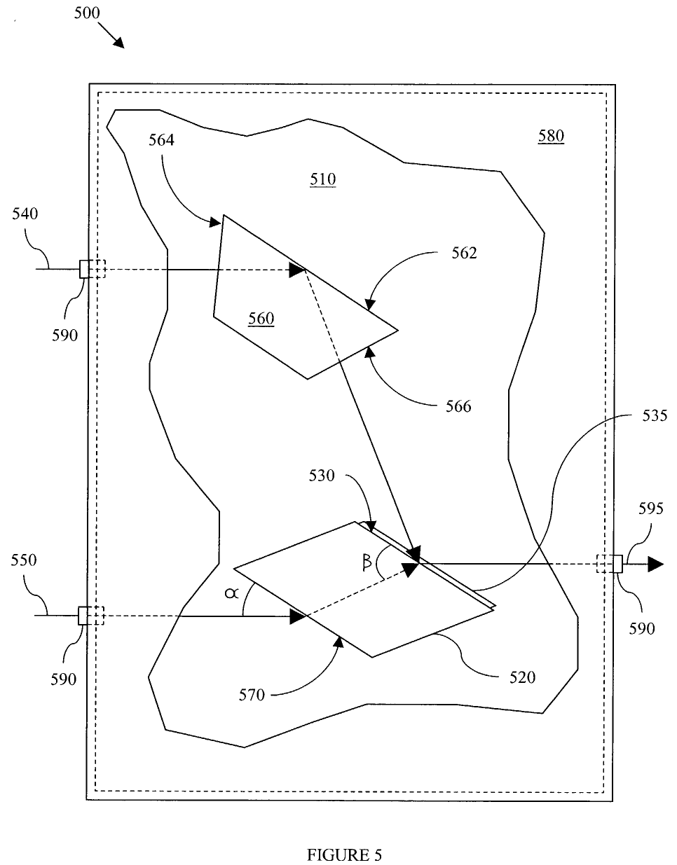

Turning to FIG. 5, illustrated is a plan view of one embodiment of an optical device 500 constructed according to the principles of the present invention. The optical device 500 includes a substrate 510 and a first optical component 520 coupled to the substrate 510. As illustrated, the first optical component 520 may include a non-immersed, transflective surface 530 having formed thereon a non-immersed, transflective coating 535. The non-immersed, transflective coating 535 is configured to reflect a first optical signal 540, having a first polarity, and simultaneously transmit a second optical signal 550, having a second polarity. The second polarity may be orthogonal to the first polarity. In one embodiment, the non-immersed, transflective coating 535 may be a conventional beam splitter coating, such as those available from Optical Coating Laboratories Incorporated of Santa Rosa, Calif., Barr Associates of Westford, Mass., and other similar companies.

As shown in the illustrative embodiment, the optical device 500 may also include a second optical component 560 coupled to the substrate 510 and located proximate the first optical component 520. By proximate, it is intended that the second optical component 560 is located close enough to the first optical component 520, and adequately oriented, for the second optical component 560 to be in optical communication with the first optical component 520.

The second optical component 560 may reflect or otherwise redirect the optical signal 540 towards the non-immersed, transflective 530 of the first optical component 520. As shown in the illustrative embodiment, the second optical component 560 may be a trapezoidal-shaped prism, although other shapes are within the scope of the present invention. The second optical component 560 may have a first surface 562 that has a reflective coating located thereon, thereby encouraging internal reflection of the optical signal 540 incident thereon. The internal reflection may be total internal reflection, as known to those skilled in the art. The second optical component 560 may also have anti-reflective coatings (not shown) on a second surface 564 and a third surface 566, thereby encouraging substantially complete transmission of the optical signal 540 therethrough.

In one embodiment, the first optical component 520 may have a another surface 570 that may be parallel to the non-immersed, transflective surface 530. The first optical component 520 may be oriented in relation to the second optical signal 550 such that the angle of incidence of the second optical signal 550 upon the surface 570 may be a predetermined angle α. In one embodiment, the predetermined angle α may be about equal to Brewster's angle, as conventionally known to those having skill in the art. Briefly, Brewster's angle is that angle of incidence at which an incident signal will not reflect away from object surface, but will substantially or completely transmit through the object surface. The second optical signal 550 may also be incident upon the non-immersed, transflective surface 530 at a predetermined angle β, which may also approximate Brewster's angle, thereby preventing any loss in signal power attributed to internal reflection. In one embodiment, one or both of the angles α and β may differ from Brewster's angle by an amount ranging between about 0° and about 10°. In an advantageous embodiment, one or both of the angles α and β may differ from Brewster's angle by an amount ranging between about 0° and about 1°.

As shown in the illustrative embodiment of FIG. 5, the substrate 510 may be enclosed in a housing 580, shown in FIG. 5 as having a central portion removed for clarity. The housing 580 may enclose the optical device 500 to provide protection from contaminants and foreign debris. In one embodiment, the housing 580 and the substrate 510 may be hermetically sealed. The housing 580 may also include signal terminals 590 providing means for introducing the optical signals 540 and 550 into the housing 580, as well as for transmitting a complex optical signal 595 having multiple polarization components as a result of the combination of the orthogonally polarized optical signals 540 and 550. The signal terminals 590 may include or be couplable to optical fibers, or pigtails as known to those skilled in the art. In one embodiment, the signal terminals 590 through which the optical signals 540 and 550 are introduced into the housing 580 may introduce the optical signals 540 and 550 substantially parallel to one another. In certain embodiments, the optical signals 540 and 550 may be filtered or collimated prior to reaching the optical components 520 and 560 by optical devices (not shown) located outside the housing 580, and/or inside the housing 580 and between the terminals 590 and the optical components 520 and 560.

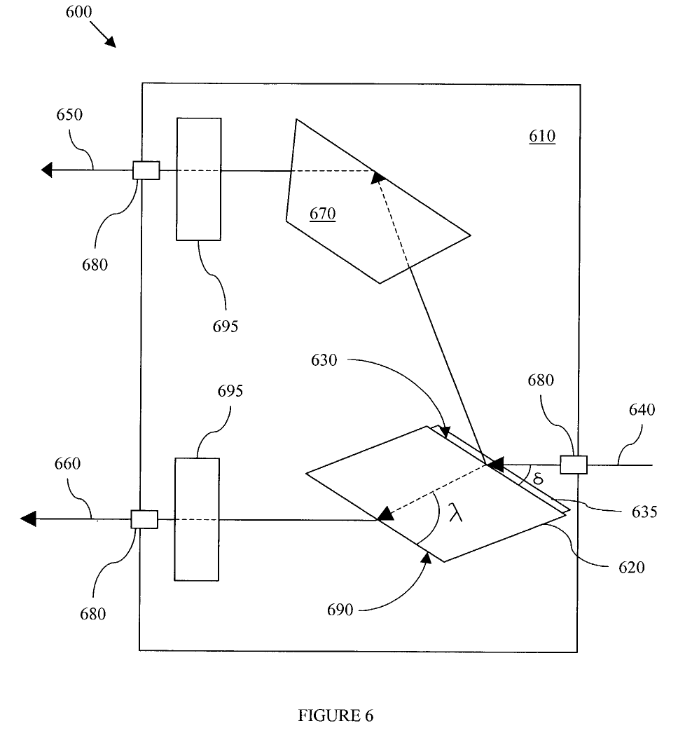

Turning to FIG. 6, illustrated is a plan view of one embodiment of an optical device 600 constructed according to the principles of the present invention. The optical device 600 may be similar, in one embodiment, to the optical device 500. However, wherein the optical device 500 may be used to combine polarized signals into a complex signal having multiple polarization components, the optical device 600 may be used in reverse to split a complex optical signal having multiple polarization components into separate optical signals having different polarities. As one skilled in the art understands, the principles of physics generally allow the devices 500 and 600 to be operated in reverse.

The optical device 600 includes a substrate 610 and a first optical component 620 coupled to the substrate 610. The first optical component 620 includes a non-immersed, transflective surface 630 having formed thereon a non-immersed, transflective coating 635. A complex optical signal 640 having multiple polarization components is directed at the non-immersed, transflective surface 630. The non-immersed, transflective coating 635 on the non-immersed, transflective surface 630 reflects a first optical signal 650 and simultaneously transmits a second optical signal 660. The first optical signal 650 includes a first component of the complex optical signal 640 having a first polarity, while the second optical signal 660 includes a second component of the complex optical signal 640 having a second polarity. The second polarity may be orthogonal to the first polarity.

The optical device 600 may also include a second optical component 670 coupled to the substrate 610 and located proximate the first optical component 620. The second optical component 670 may reflect or otherwise redirect the optical signal 650 between the non-immersed, transflective surface 630 of the first optical component 620 and a signal terminal 680, which may be similar to the signal terminals 590 described with reference to FIG. 5.

In one embodiment, the first optical component 620 may have a another surface 690 that may be parallel to the non-immersed, transflective surface 630. The first optical component 620 may be oriented in relation to the complex optical signal 640 such that the angle of incidence of the complex optical signal 640 upon the non-immersed, transflective surface 630 may be a predetermined angle δ. In one embodiment, the predetermined angle δ may be about equal to Brewster's angle. The second optical signal 660 may be incident upon the surface 690 at a predetermined angle λ, which may also approximate Brewster's angle, thereby preventing any loss in signal power attributed to internal reflection. In one embodiment, one or both of the angles δ and λ may differ from Brewster's angle by an amount ranging between about 0° and about 10°. In an advantageous embodiment, one or both of the angles δ and λ may differ from Brewster's angle by an amount ranging between about 0° and about 1°.

The optical device 600 may also include one or more auxiliary optical components 695, such as those shown coupled to the substrate 610 between the optical components 620 and 670 and the signal terminals 680. An auxiliary component 695 may be a filter, a collimator, a prism, a lens or other optical component as needed in a particular application. For instance, the auxiliary components 695 may be polarizers if additional polarization purity is needed.

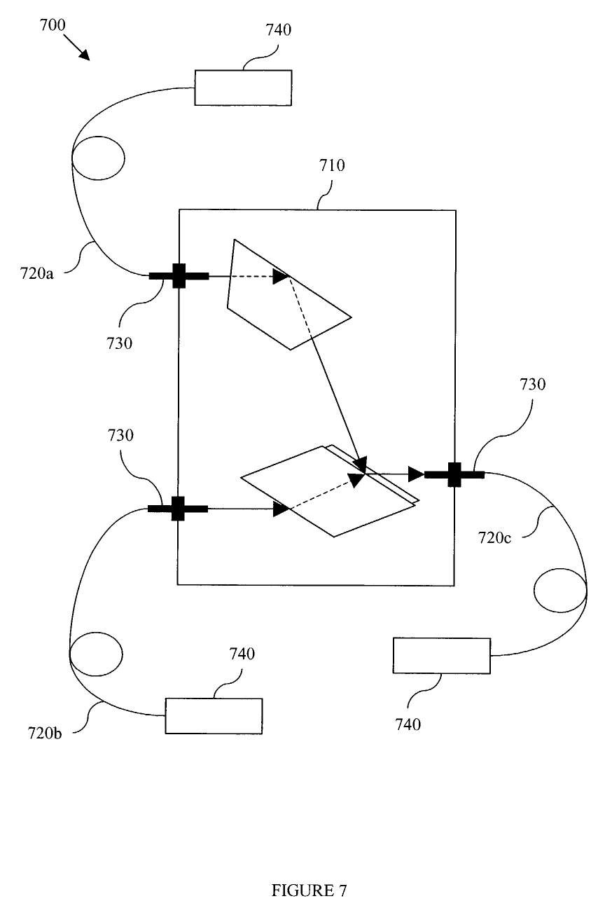

Turning to FIG. 7, illustrated is a plan view of one embodiment of an optical communication system 700 which may form one environment in which a device similar to the optical device 500 and/or the optical device 600 may be used. The optical communication system 700 includes an optical device 710, which may be identical or similar to the optical device 500 or the optical device 600, and one or more optical fibers 720 coupled to the optical device 710. The fibers 720 may be coupled to the optical device 710 at terminals 730 of the optical device 710.

In an embodiment where the optical device 710 is employed as a polarized optical beam combiner, such as that described in reference to FIG. 5, the fibers 720a and 720b may transmit input signals having different polarizations, and fiber 720c may receive and transmit a complex optical signal resulting from the combination of the two differently polarized input signals having multiple polarization components, as shown in the illustrative embodiment. The different polarizations of the input signals may be orthogonal.

Although not functionally depicted in FIG. 7, an embodiment exists where the optical device 710 is employed as a polarized beam splitter, such as that described with reference to FIG. 6. In such an embodiment, the fiber 720c may introduce to the optical device 710 a complex optical signal provided by another optical component 740 and having multiple polarization components, and the fibers 720a and 720b may transmit output signals having different polarizations. The different polarizations of the output signals may be orthogonal.

Regardless of whether the optical device 710 is employed as an optical beam combiner or splitter, the optical components 740 may be located within the optical communication system 700 or may be ancillary thereto. A combined, complex optical signal or separated, polarized optical signals may exit the optical device 710 to be further used by additional optical components, such as the optical components 740 shown, or by components located elsewhere within or beyond the optical communication system 700. In one embodiment, the optical components 740 may include light sources, such as light pumps, lasers, or other optical transmitters. In another embodiment, the optical components 740 may include optical processing elements, such as wavelength division multiplexer elements, optical distributor elements, polarizer elements, collimator elements, or directing elements. The optical components 740 may also include various other optoelectronic devices, such as laser diodes.

Although the present invention has been described in detail, those skilled in the art should understand that they can make various changes, substitutions and alterations herein without departing from the spirit and scope of the invention in its broadest form.

What is claimed is:

1. A method of combining or splitting optical signals, comprising:
reflecting a first optical signal having a first optical polarity from a non-immersed, transflective surface of an optical component; and
transmitting a second optical signal having a second optical polarity through said non-immersed, transflective surface.

2. The method as recited in claim 1 wherein said reflecting and said transmitting include combining said first and second optical signals.

3. The method as recited in claim 1 wherein said reflecting and said transmitting include splitting said first and second optical signals.

4. The method as recited in claim 3 further comprising individually filtering said first and second optical signals.

5. The method as recited in claim 1 wherein said transmitting includes directing said second optical signal at a predetermined angle of incidence onto a surface of said optical component that is parallel said non-immersed, transflective surface.

6. The method as recited in claim 5 wherein said predetermined angle of incidence is about equal to Brewster's Angle.

7. The method as recited in claim 1 further comprising redirecting said first optical signal between said transflective surface and a signal terminal.

8. The method as recited in claim 7 wherein said optical component is a first optical component and said redirecting includes redirecting through a second optical component.

9. The method as recited in claim 8 wherein said redirecting includes redirecting by internal reflection from a first surface of said second optical component.

10. An optical device, comprising:
a substrate; and
an optical component coupled to said substrate and having a non-immersed, transflective surface that reflects a first optical signal having a first polarity and simultaneously transmits a second optical signal having a second polarity.

11. The optical device as recited in claim 10 wherein said optical component is a first optical component, and further including a second optical component coupled to said substrate and located proximate said first optical component that redirects said first optical signal.

12. The optical device as recited in claim 11, further including a first and second filter coupled to said substrate and located proximate said first and second optical components, respectively.

13. The optical device as recited in claim 11 wherein said first optical component is a parallelogram-shaped prism and said second optical component is a trapezoidal-shaped prism.

14. The optical device as recited in claim 10 wherein said optical component further includes a surface parallel to said transflective surface, and wherein said optical component is positioned such that said second optical signal is incident upon said parallel surface at a predetermined angle of incidence.

15. The optical device as recited in claim 14 wherein said predetermined angle of incidence is about equal to Brewster's Angle.

16. The optical device as recited in claim 10 wherein said substrate is enclosed in an optical housing.

17. The optical device as recited in claim 16, wherein said optical housing is hermetically sealed.

18. The optical device as recited in claim 10 wherein said optical device is included within an optical communications system including a transmitter or a receiver.

19. An optical communication system, comprising:
an optical device, including:
a substrate;
a first optical component coupled to said substrate and having a transflective surface that reflects a first optical signal having a first polarity and simultaneously transmits a second optical signal having a second polarity; and
a second optical component coupled to said substrate and located proximate said first optical component and that redirects said first optical signal; and
an optical fiber coupled to the optical device.

20. The optical communication system as recited in claim 19 further including a wavelength division multiplexer coupled to said optical device.
